(19) United States
(12) Patent Application Publication
(10) Pub. No.: US 2016/0253865 A1
(43) Pub. Date: Sep. 1, 2016

(54) System for Connecting Physical and Remote Virtual Gaming Terminals in Real Time for Simultaneous Game Play

(71) Applicant: Boxu Men, Richmond (CA)

(72) Inventors: Li Men, Richmond (CA); Boxu Men, Richmond (CA)

(21) Appl. No.: 15/149,142

(22) Filed: May 8, 2016

Related U.S. Application Data
(63) Continuation-in-part of application No. PCT/CN2015/078383, filed on May 6, 2015.

(30) Foreign Application Priority Data
May 13, 2014 (MO) I/001291

(51) Int. Cl. G07F 17/32

(52) U.S. Cl. CPC G07F 17/3225

(57) ABSTRACT

The present invention relates to electronic gaming equipment and the connection thereof. More specifically, the present invention is a system to connect physical electronic and remote virtual gaming terminals via a central network platform, so that players at physical and remote locations can play the same games simultaneously in real time. The gaming terminals can be implemented in a physical casino, as well as via a virtual terminal at a remote location.

### CROSS-REFERENCES TO RELATED APPLICATIONS

The present application is a Bypass Continuation In Part, filed under 35 USC 111(a) and 37 CFR 1.53(b), of a pending PCT application with serial number PCT/CN2015/078383, filed on May 6, 2015, which in turn claims priority to a Chinese/Macau application number I/001291 (MO), filed on May 13, 2014. The disclosures of both are herewith incorporated by reference in its entirety.

### TECHNICAL FIELD

The present invention relates to electronic gaming equipment and the connection thereof. More specifically, the present invention is a system to connect physical and remote virtual electronic gaming terminals via a central network platform, so that players at physical and remote locations can play the same games simultaneously in real time. The electronic gaming terminals can be implemented in a physical gaming facility (such as a casino), as well as via a virtual terminal at a remote location.

### BACKGROUND OF THE INVENTION

The operation of commercial gaming facilities or casinos is legally restricted in the US. Traditional casinos often belong to a larger consortium, which in turn operates at various physical locations, such as in upscale hotels or near popular vacation attractions. These types of casinos usually employ various physical gaming devices to produce random results in physical ways, such as shuffling cards or throwing dices. Good reputation and years of experiences are important to these gaming facilitys, because customers are more likely to visit and re-visit if they believe that there is a fair chance of wining any prize.

One of the major disadvantages of traditional casinos is the limitation of space and time in terms of its operation. For example, there are only a few States that allow commercial gambling. The vast majority of customers visit casinos only during a chance of traveling. Luxurious decorations and fancy gourmet itself is not enough to entice customers for repeated business.

Online casinos or gaming facilities alike operate over an Internet platform, and can overcome the constraint of space and time. Any person, anywhere and anytime, in principle can log onto an online casino and participate in whatever gaming activities that is offered. Since these types of online games are purely digital and cannot be tied up with any physical property, credibility is often a problem for players. Fraud may occur in many steps along the process, and therefore it is difficult to dispel players' doubt on the fairness of the online casinos.

The present invention, as illustrated in FIG. 1, is a system to connect physical and remote virtual electronic gaming terminals via a central network platform, so that players at physical and remote locations can play the same games simultaneously in real time.

### BRIEF SUMMARY OF EMBODIMENTS OF THE INVENTION

The present invention relates to physical and virtual electronic gaming equipment and the connection thereof. The electronic gaming equipment can be implemented in a physical casino, as well as via a virtual terminal at a remote location.

In a variant, a system connecting physical electronic gaming terminals at a gaming facility with remote virtual gaming terminals comprising a physical electronic gaming terminal where a plurality of players physically present at the terminal, as well as players logged in from remote locations through remote virtual gaming terminals, participate in a game simultaneously; a video module; and a central network platform comprising processors and computer readable medium having instructions stored thereon.

In another variant, the physical electronic gaming terminal further comprises: a plurality of individual player modules, with each individual player module comprising a player computer connected to a player touch screen display; a plurality of inductive card reading devices to identify players and dealers; a dealer module connected to a dealer computer; and at least one common display screen.

In yet another variant, the player computer further comprises a processor and a computer readable medium having instructions stored thereon, that when executed by the processor cause the processor to receive a game play event from the central network platform, to display the game play event onto the player touch screen display, to record an interaction from an individual player, to process and to determine a new state of the game play event, and to transmit the new state of the game play event back to the central network platform.

In still another variant, the player touch screen display further comprises: a player gaming interface to display a game event with corresponding rules of play, to record an action from an individual player, to send a state of the action to the player computer; a live video display of other players; game statistics; and account summary with winnings and losses.

In a variant, the dealer computer further comprises a processor and a computer readable medium having instructions stored thereon, that when executed by the processor cause the processor to receive a game play event from the central network platform, to display the game play event onto the common display screen, to administer a game by recording an interaction with a dealer, to process and to determine a new state of the game play event, and to transmit the new state of the game play event to the central network platform.

In another variant, the dealer computer administers a game and records an interaction with a dealer via a dealer touch screen display comprising a dealer gaming interface to display a game event with corresponding rules of play, to record an action from a dealer, to record an action from an individual player, to send a new state of the game to the dealer computer.

In yet another variant, the dealer computer administers a game and records an interaction with a dealer by: allowing a dealer to administer a game event by using conventional gaming equipment; receiving live video feed of a dealer in real time while the dealer administers the game event using conventional gaming equipment; sending live video feed of the game event as administered by the dealer to physical and remote virtual gaming terminals via the central network platform; and receiving a response from physical and virtual players via physical and virtual gaming terminals connected to the network platform.

In still another variant, the common display screen of claim 2 further comprises a state of a game play event, rules of a game play event, a state of a game play event as administered by a dealer, game statistics, player summary, winnings and losses info.

In a variant, the remote virtual gaming terminal further comprises a processor and a computer readable medium having instructions stored thereon, that when executed by the processor cause the processor to receive and to display a live video feed of the physical electronic gaming terminals and other players, to receive a game play event from the central network platform, to display the game play event onto a screen, to administer a game, to record an interaction with a remote player, to process and to determine a new state of the game play event, to transmit the new state of the game play event back to the central network platform, and to display an account summary with winnings and losses.

In another variant, a remote player connects to a physical electronic gaming terminal via a virtual gaming interface connected to the central network platform: to receive a live video feed of the physical electronic gaming terminal; to display the live video feed of the dealer and of other players at the physical electronic gaming terminal; to receive and to display a game play event with corresponding rules of play as administered at the physical gaming terminal; to record an interaction from the remote player; to send a state of the interaction from the remote player to the physical and virtual gaming terminals connected to the central network platform; and to display game results, statistics and account summary with winnings and losses.

In yet another variant, a remote player connects to a plurality of physical electronic gaming terminals via a plurality of corresponding virtual gaming interfaces.

In still another variant, video module further comprises: an array of video cameras installed around and connected to a plurality of physical electronic gaming terminals; a central receiving and sorting module to incorporate live video feeds from the cameras into a central security system; and a delivery module to deliver live video feeds from the cameras to physical and virtual gaming terminals.

In a variant, the delivery module delivers live video feed from relevant cameras to remote virtual gaming terminals only after a remote player and a physical electronic gaming terminal are both identified and are cleared of all security requirements.

In another variant, the central network platform further comprises: a user management module to set up accounts, to manage logins and securities, to record gaming history, to communicate, and to manage user funds; a gaming terminal management module to execute actual games, to record remote and physical player responses, to dynamically process iterations of game states based on the responses, to conclude games and to calculate winnings and losses; a video processing module to receive live video feeds from each physical electronic gaming terminals and from casino video surveillance, to sort relevant videos, to composite various views into coherent viewing sequences in space and in time, to compress and to send relevant videos to players; a finance management module for receiving, calculating, sorting, and distributing funds from users as well as from banks dealing with the gaming facility; and computer hardware/software, cables, optical fiber connections on which the system operates.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates the basic concept and main components of the present invention.

FIG. 2 is a perspective 3D view of a physical electronic gaming terminal situated in a casino.

FIG. 3 is a 2D schematic of the physical electronic gaming terminal viewed from above.

FIG. 4 to illustrate an exemplary view of a game interface.

FIG. 5 is a schematic view of a virtual gaming terminal interface.

FIG. 6 is a snapshot of an implementation of the virtual gaming terminal on a remote mobile tablet.

FIG. 7 is a snapshot of an implementation of the virtual gaming terminal on a remote mobile phone.

FIG. 8 is a schematic of an implementation of the video module in the present invention.

FIG. 9 a schematic of a casino hall with arrays of video cameras controlled by the video module.

FIG. 10 illustrates main components of the present invention and their relations to each other.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention relates to electronic gaming equipment and the connection thereof. More specifically, the present invention is a system and method to connect physical and virtual electronic gaming terminals via a network platform, so that players at physical and remote locations can play the same games simultaneously in real time. The electronic gaming terminals can be implemented in a physical casino, as well as via a virtual terminal at a remote location.

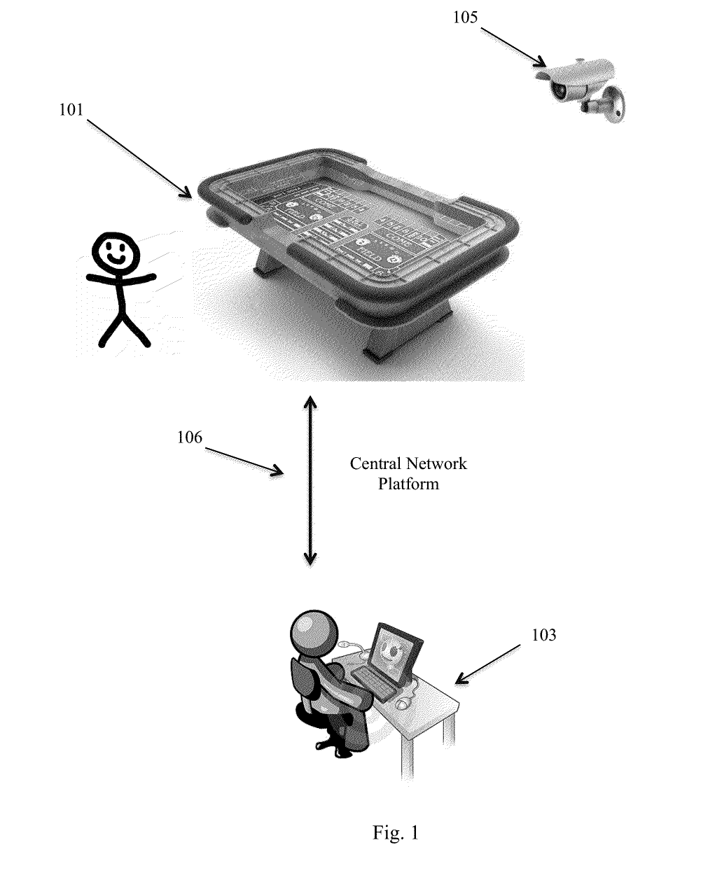

FIG. 1 illustrates the basic concept and main components of the present invention. A physical electronic gaming terminal (or game table) 101 is situated in a casino for players who are physically visiting and playing at the casino. A virtual gaming terminal 103 is situated in a remote location, potentially anywhere in the world, for players who want to play the same casino game from a remote location. Video cameras 105 at the casino record and transmit the live game via a central network platform 106 to the remote player. The central network platform is designed to execute a game and calculate results by taking game responses from players both at the casino and at the remote locations.

### Physical Electronic Gaming Terminals

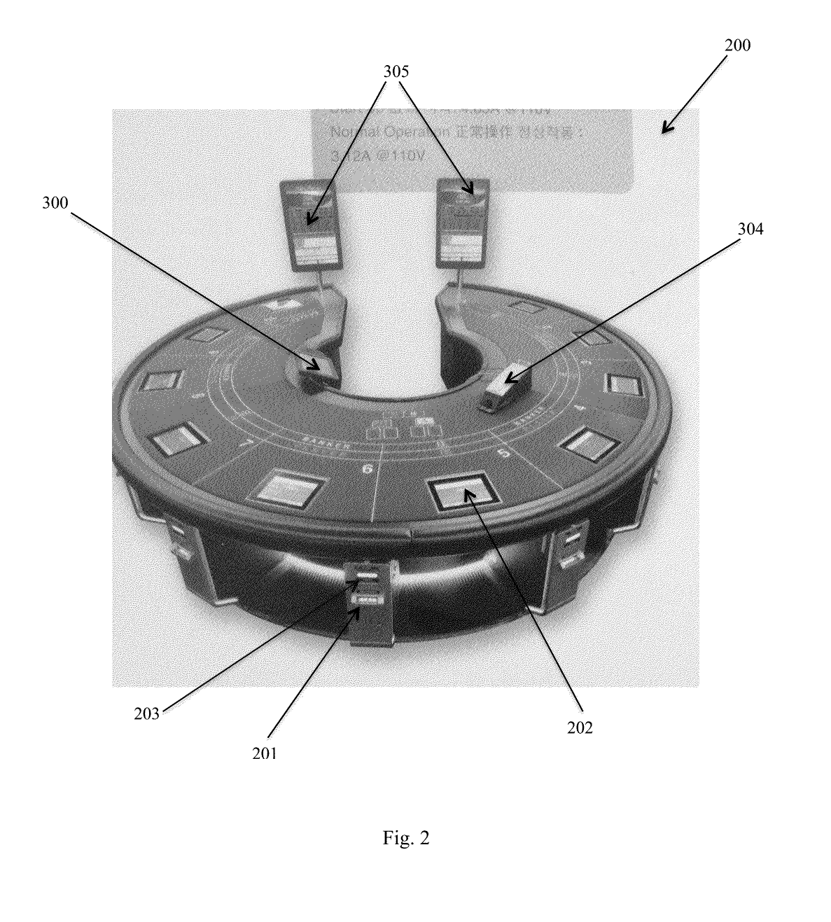

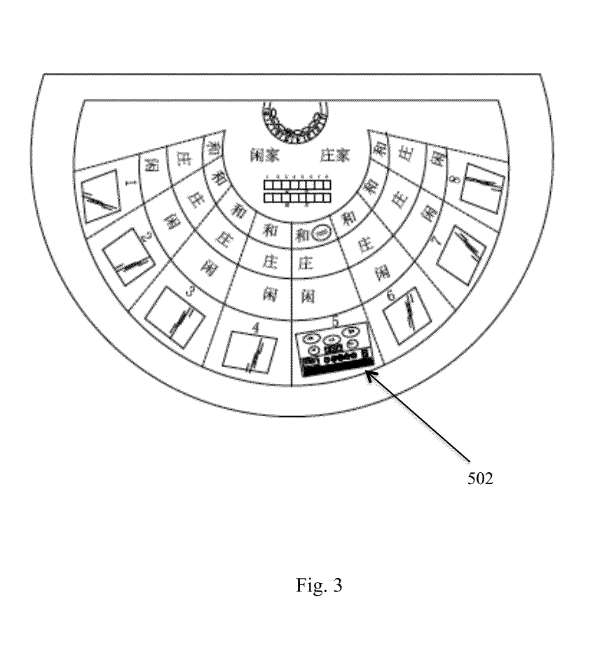

FIG. 2 is a perspective 3D view of a physical electronic gaming terminal situated in a casino. FIG. 3 is a 2D schematic of the physical electronic gaming terminal viewed from above.

The physical electronic gaming terminal situated in a physical gaming facility, such as a casino, can accommodate a plurality of players. Each player occupies an individual player module at the terminal. For instance, the gaming terminal 200 illustrated in FIG. 2 can host 10 players labeled from 1 through 10 on the top surface, and thus comprises 10 individual player modules. Each individual player module comprises a player computer 203, connected to a player touch screen display 202, and an inductive card-reading device 201.

The inductive card-reading device 201 serves the purpose of identifying a player who is in passion of a casino card. The casino card, for example, records a player's room number, credit card information, account balance, winnings and losses, and gaming history etc. When a player scan the casino card in front of the inductive card-reading device, he or she will be identified by the player computer 203, and then prompted to confirm to join the game at that gaming terminal. Subsequent gaming histories, performances, winnings and losses will be recorded and updated onto the casino card. Player will also be prompted to confirm to leave the game terminal if he or she chooses to do so.

The player touch screen display 202 serves as a gaming interface to receive a game via the player computer 203, to display the game, to record interactions of the player during the play of the game, and to send player responses back to the player computer. The touch screen displays additional information such as gaming rules, game statistics, live video feeds, relevant info about other players, winnings and losses, and account information. The touch screen can also be programed to allow a player access to his or her funds in order to continue playing the game.

The player computer 203 serves as the central command center for the player module. It mainly receives games from the casino's central network platform, executes and displays the game onto the player touch screen display, records a player's responses to the games, processes the responses based on the rules of the games, and sends the results of the games and relevant information back to the central network platform.

The player computer 203 identifies a player physically in front of the player module via an inductive card reader. The player computer 203 can also identify a player who is physically NOT in front of the player module via remote log in. Details of how a remote player accesses the player module will be elaborated further in a later section relating to the virtual gaming terminals.

The player computer 203 together with the player touch screen display will also guide a new player to set up an initial account either in front of the player module or through remote log in.

The physical electronic gaming terminal situated in a physical gaming facility also comprises at least one dealer module 300. The dealer module further comprises at least a dealer computer and a dealer touch screen display.

As soon as the dealer computer identifies a dealer, he or she can administer a game via the dealer touch screen display. The game is received from the casino's central network platform. The dealer can administer the game to the players physically present at the player modules, as well as to remote players who have logged in onto his or her terminal.

The dealer touch screen display serves as a gaming interface to receive a game via the dealer computer, to display the game, to record interactions of the dealer during the play of the game, and to send dealer responses back to the dealer computer. The touch screen displays additional information such as gaming rules, game statistics, live video feeds, relevant info about players, and winnings and losses etc. The touch screen can also be programed to allow a dealer to distribute funds during a game play.

Apart from using the dealer touch screen display to administer a game, a dealer can also employ conventional gaming equipment, such as cards 304, dices, and etc. For remote players, live video feed of the dealer's game play is sent in real time, so that they can respond and engage in the play also in real time, based on the rules of the game. The remote players can achieve this via a virtual gaming terminal, which will be described in the following section.

The physical electronic gaming terminal situated in a physical gaming facility also comprises at least one common display screen 305. The common display screen is designed to provide more information to players, both remote and physical, as well as to dealers. These comprises current state of the game event, game rules, history, statistics, player summary, live video feed, winnings and losses, and etc.

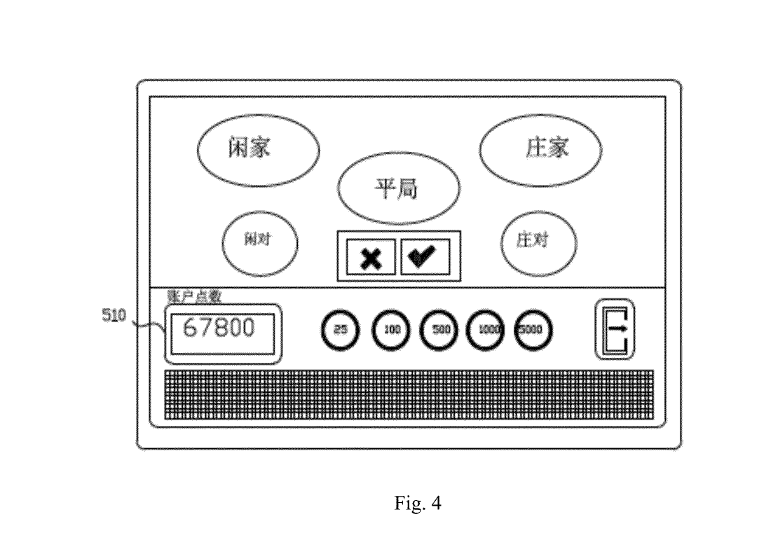

FIG. 3 is a 2D schematic of the physical electronic gaming terminal (of a sample Baccarat game) viewed from above. For player #5, a touch screen display 502 is further enlarged in FIG. 4 to illustrate an exemplary view of the game interface. Account balance is depicted by label 510. The game interface illustrated in FIG. 4 is only one sample out of many possible configurations. The present invention allows the casino a great amount of flexibility to customize this interface for different games, languages, user group and so on. The dealer interface and the common display screen can also be customized in similar fashion as needed.

### Remote Virtual Gaming Terminals

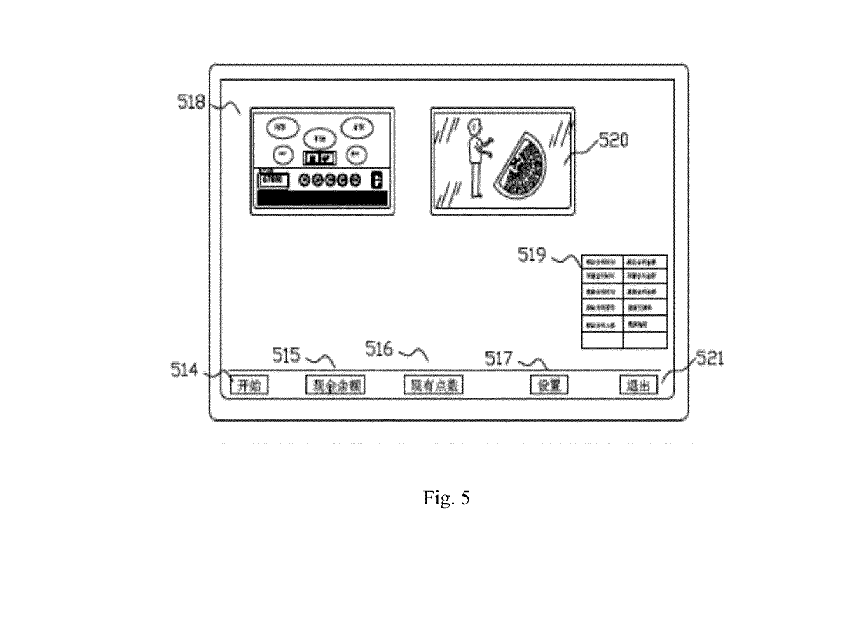

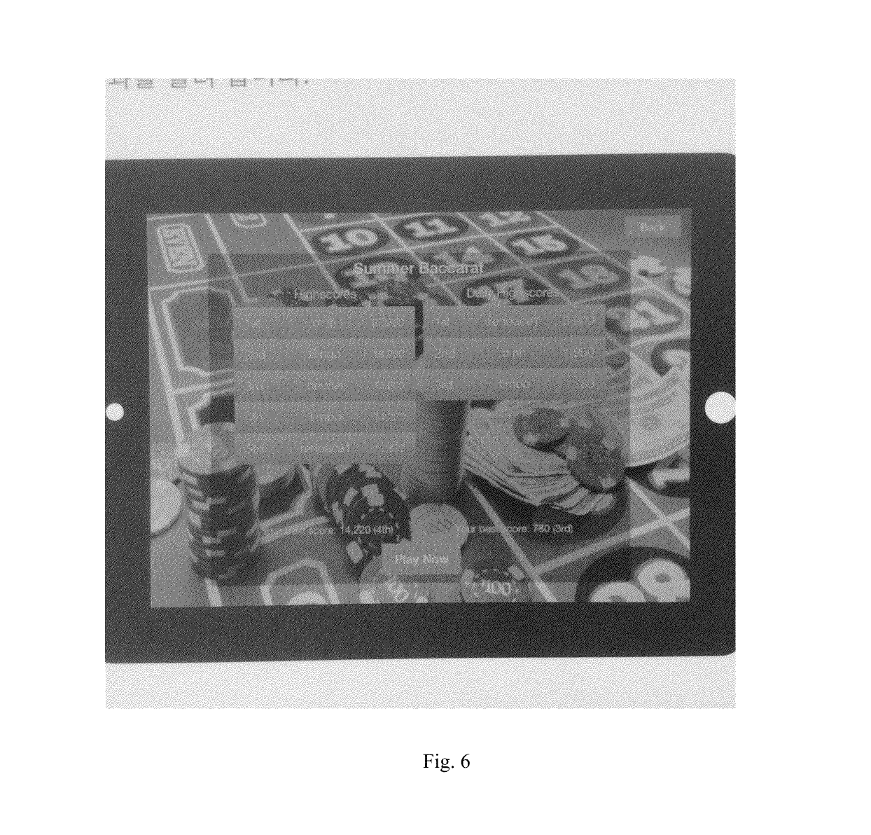

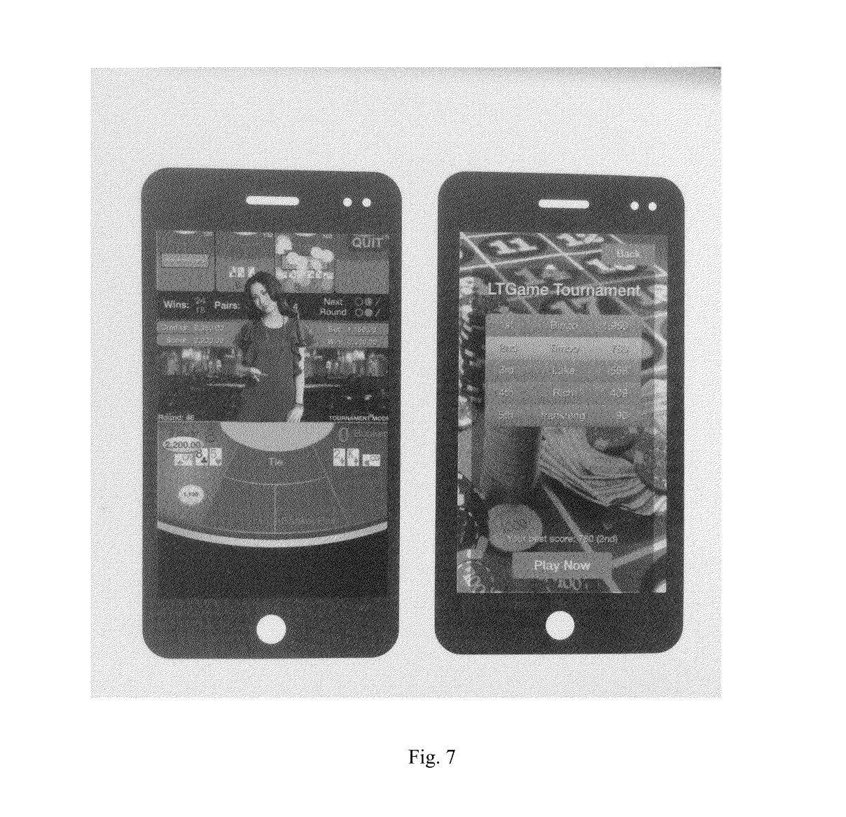

FIG. 5 is a schematic view of a virtual gaming terminal interface. FIGS. 6 and 7 are snapshots of an implementation of the virtual gaming terminal on a remote mobile tablet and a mobile phone device.

The remote virtual gaming terminal is implemented via an application, and is customized to adapt to various hardware requirements. Since a player's instant responses are essential while engaging in real time casino game play, hardware requirements must be met. For instance, if a desktop computer is used, the application can potentially utilize the screen, keyboard, mouse, microphone, and camera to receive a game play and to record player responses. Similar implementation applies to a laptop computer, and can add functionality specifically associated with a track pad, which is mainly available to a laptop computer. For mobile devices such as a tablet or a phone, speakers and touch screen technology is readily available, so that a player can use voices, fingers and gestures to engage in various game plays. For gaming devices, a player can utilize joysticks, track balls, handheld game pads, headphones, TV screens, and even body movements that are tracked by local video modules and then fed back to the application in virtual game play. Not all casino games can be implemented to all hardware, but a player is informed of his or her options and hardware requirements. Proper instructions and suggestions of hardware upgrades are always available to them. The application itself remains highly flexible so that it can be quickly adapted to accommodate new hardware and accessories.

The remote virtual gaming terminal, after logging into the casino's central network platform and into a specific physical electronic gaming terminal, receives a series of live video feed surrounding the physical terminal. It receives an actual game that is being played simultaneously at the physical terminal, executes the game, allows the remote player to play the game by recording all responses from the player in real time. Player responses are then sent back to the electronic physical gaming terminal immediately. Winnings and losses are processed by counting responses from physical casino players and from remote virtual gaming terminal players.

FIG. 5 is a schematic of an exemplary interface through which a remote player can participate in live casino games in real time. After opening such an interface, a player can Login 514, view his or her Cash reserve 515, game Points 516, Settings 517, and Logout 521. While logged in, a player can view a live video stream 520 of the physical casino with physical players, games and tables of interest. A specific game interface 518 is also displayed after a player has decided on a game to play. Game interface 518 is essentially the same as the one in FIG. 4, displayed to the player physically playing in the casino. The player can use whichever hardware available to respond to the game play, and results of this interaction are sent back to the physical electronic gaming terminal in the casino. In essence, the remote player is playing a casino game in real time as if he or she is physically at the table.

During the game play, Cash and Points are constantly updated, so that a player can track his or her performances and scores. The player also has options to access and to withdraw funds. A remote player can join a single table, or can join multiple tables by opening several gaming interfaces.

FIGS. 6 and 7 are snapshots of an implementation of the virtual gaming terminal on a remote mobile tablet and a mobile phone device. Live video streaming (FIG. 5, 520) can be enlarged to occupy a whole screen, or be minimized as in FIG. 5.

### Video Module

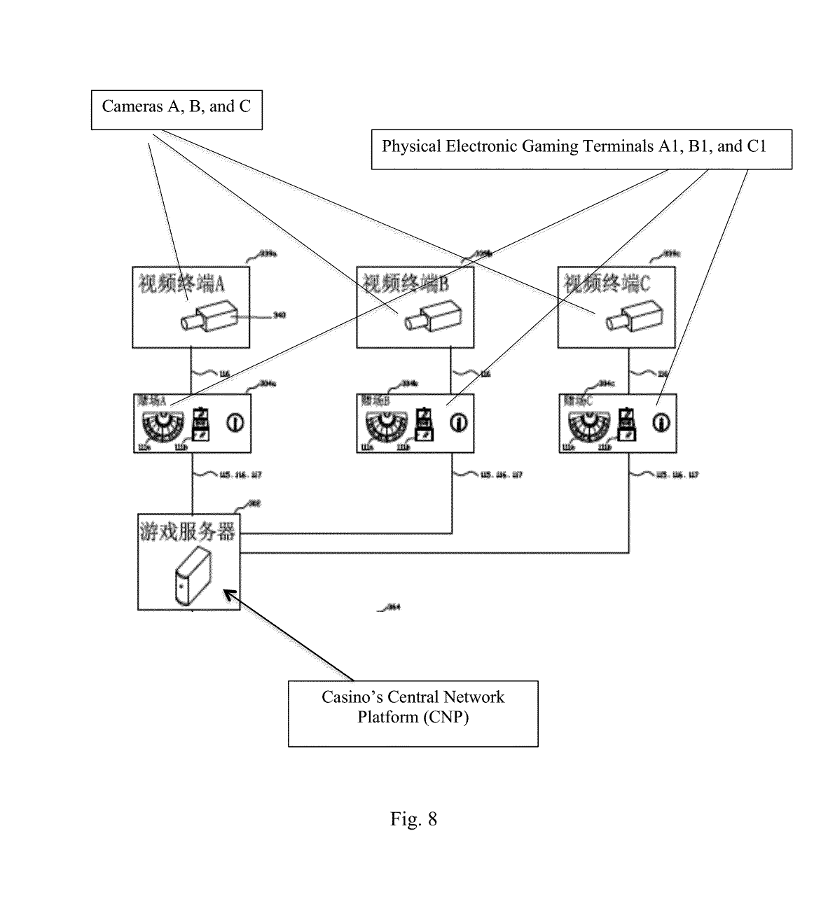

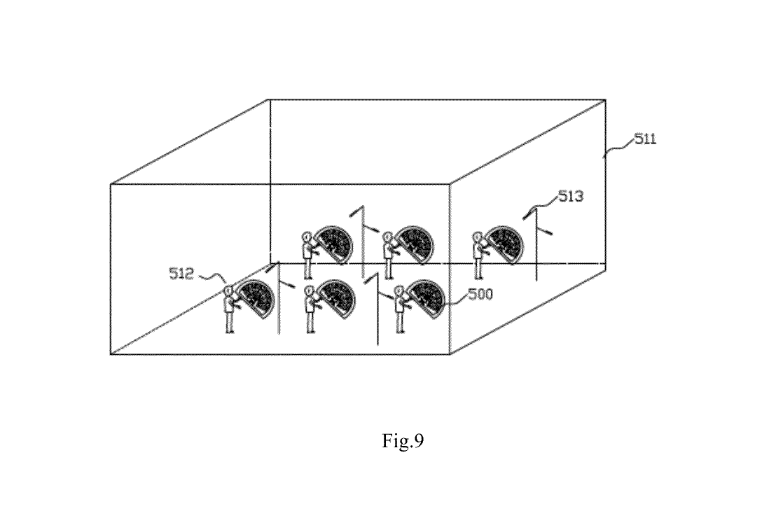

FIGS. 8 and 9 are schematics of an implementation of the video module in the present invention.

As described in the previous two sections, providing live video feeds of the physical gaming terminal in the casino to remote players is an integral part of the gaming experience. In FIG. 9, a schematic of a casino hall 511 is depicted, where many players 512 visiting the establishment are distributed across various physical gaming tables 500. The hall itself is equipped with arrays of cameras 513 throughout for security reason.

Apart from the security camera system, the present invention also employs specific cameras that are dedicated to each and every electronic physical gaming terminal and the game itself that is being played. FIG. 8 illustrates such a design where at least one camera module is employed for each table. The live video feeds are sent first to the Casino's Central Network Platform, and then to the remote player. In order for a remote player to have a much realistic 3D experience, more than one camera modules are often employed. The remote player can toggle through various views of the gaming table via corresponding functions provided through the virtual gaming interface.

The video modules dedicated to the game and the physical gaming terminals can be integrated with existing security camera system. The remote player however, only has access to the views from the cameras that is dedicated to the table that he or she is playing game on. Security checks and verification is provided to safe guard each steps along the process.

### Casino's Central Network Platform

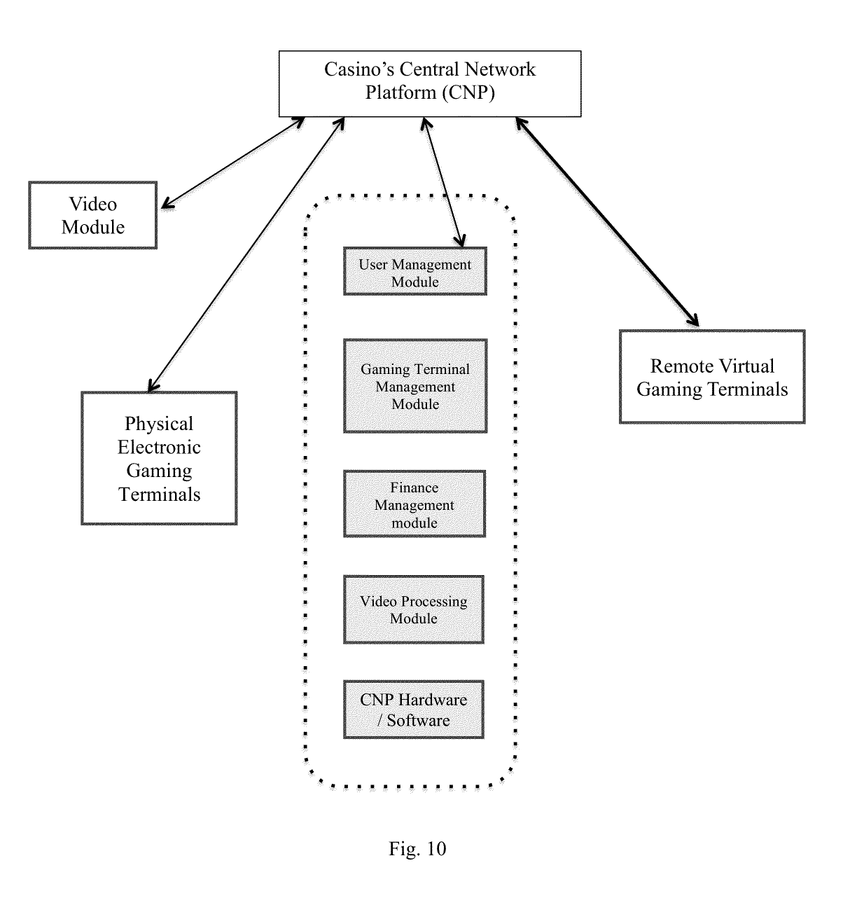

A casino's Central Network Platform (CNP) is the central command center of the present invention. FIG. 10 illustrates main components and their relations to each other. The physical electronic gaming terminals, the remote virtual gaming terminals and the video module are multi-directionally linked through the casino's central network platform.

The CNP comprises a user management module for all players remote or physical. This module deals with user's account set up, log in, gaming record, communications, exchange and management of funds etc.

The CNP comprises a gaming terminal management module. This module's main function is to execute actual games, to record remote and physical player responses, to dynamically process iterations of game states based on the responses, to conclude games and to calculate winnings and losses.

The CNP comprises a video processing module which receives live video feeds from each physical gaming terminals and from casino video surveillance, sorts relevant videos, composites various views into coherent viewing sequences in space and in time, compresses and sends relevant videos to remote players, etc.

The CNP comprises a finance management module, which is in charge of receiving, calculating, sorting, and distributing funds from users as well as from banks dealing with the casino.

The CNP also comprises various computer hardware/software, cables or optical fiber connections on which the whole system operates.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open United as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

Elements described herein as coupled have an effectual relationship realizable by a direct connection or an indirect connection with one or more other intervening elements.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system connecting physical electronic gaming terminals at a gaming facility with remote virtual gaming terminals comprising:
a physical electronic gaming terminal where a plurality of players that are physically present at the terminal, as well as a plurality of players logged in from remote locations through remote virtual gaming terminals, participate in a game simultaneously;
a video module dedicated to the physical electronic gaming terminal; and
a central network platform comprising processors and computer readable medium having instructions stored thereon to administer games, to receive and to process game responses, and to conclude game outcomes for all players both from physical and remote locations.

2. The system connecting physical electronic gaming terminals at a gaming facility with remote virtual gaming terminals of claim 1, wherein the physical electronic gaming terminal further comprises:
a plurality of individual player modules, with each individual player module comprising a player computer connected to a player touch screen display;
a plurality of inductive card reading devices to identify players and dealers;
a dealer module connected to a dealer computer; and
at least one common display screen.

3. The individual player modules of claim 2, wherein the player computer further comprises a processor and a computer readable medium having instructions stored thereon, that when executed by the processor cause the processor to receive a game play event from the central network platform, to display the game play event onto the player touch screen display, to record an interaction from an individual player, to process and to determine a new state of the game play event, and to transmit the new state of the game play event back to the central network platform.

4. The individual player module of claim 2, wherein the player touch screen display further comprises:
a player gaming interface to display a game event with corresponding rules of play, to record an action from an individual player, to send a state of the action to the player computer;
a live video display of other players;
game statistics; and
account summary with winnings and losses.

5. The dealer module of claim 2, wherein the dealer computer further comprises a processor and a computer readable medium having instructions stored thereon, that when executed by the processor cause the processor to receive a game play event from the central network platform, to display the game play event onto the common display screen, to administer a game by recording an interaction with a dealer, to process and to determine a new state of the game play event, and to transmit the new state of the game play event to the central network platform.

6. The dealer module of claim 2, wherein the dealer computer administers a game and records an interaction with a dealer via a dealer touch screen display comprising a dealer gaming interface to display a game event with corresponding rules of play, to record an action from a dealer, to record an action from an individual player, to send a new state of the game to the dealer computer.

7. The dealer module of claim 2, wherein the dealer computer administers a game and records an interaction with a dealer by:
allowing a dealer to administer a game event by using conventional gaming equipment;
receiving live video feed of a dealer in real time while the dealer administers the game event using conventional gaming equipment;
sending live video feed of the game event as administered by the dealer to physical and remote virtual gaming terminals via the central network platform; and
receiving a response from physical and virtual players via physical and virtual gaming terminals connected to the network platform.

8. The common display screen of claim 2 further comprises a state of a game play event, rules of a game play event, a state of a game play event as administered by a dealer, game statistics, player summary, winnings and losses info.

9. The system connecting physical electronic gaming terminals at a gaming facility with remote virtual gaming terminals of claim 1, wherein the remote virtual gaming terminal further comprises a processor and a computer readable medium having instructions stored thereon, that when executed by the processor cause the processor to receive and to display a live video feed of the physical electronic gaming terminals and other players, to receive a game play event from the central network platform, to display the game play event onto a screen, to administer a game, to record an interaction with a remote player, to process and to determine a new state of the game play event, to transmit the new state of the game play event back to the central network platform, and to display an account summary with winnings and losses.

10. The remote virtual gaming terminal of claim 9, wherein a remote player connects to a physical electronic gaming terminal via a virtual gaming interface connected to the central network platform:
to receive a live video feed of the physical electronic gaming terminal;
to display the live video feed of the dealer and of other players at the physical electronic gaming terminal;
to receive and to display a game play event with corresponding rules of play as administered at the physical gaming terminal;
to record an interaction from the remote player;
to send a state of the interaction from the remote player to the physical and virtual gaming terminals connected to the central network platform; and
to display game results, statistics and account summary with winnings and losses.

11. The remote virtual gaming terminal of claim 9, wherein a remote player connects to a plurality of physical electronic gaming terminals via a plurality of corresponding virtual gaming interfaces.

12. The system connecting physical electronic gaming terminals at a gaming facility with remote virtual gaming terminals of claim 1, wherein the video module further comprises:
an array of video cameras installed around and connected to a plurality of physical electronic gaming terminals;
a central receiving and sorting module to incorporate live video feeds from the cameras into a central security system; and
a delivery module to deliver live video feeds from the cameras to physical and virtual gaming terminals.

13. The video module of claim 12, wherein the delivery module delivers live video feed from relevant cameras to remote virtual gaming terminals only after a remote player and a physical electronic gaming terminal are both identified and are cleared of all security requirements.

14. The system connecting physical electronic gaming terminals at a gaming facility with remote virtual gaming terminals of claim 1, wherein the central network platform further comprises:
a user management module to set up accounts, to manage logins and securities, to record gaming history, to communicate, and to manage user funds;
a gaming terminal management module to execute actual games, to record remote and physical player responses, to dynamically process iterations of game states based on the responses, to conclude games and to calculate winnings and losses;
a video processing module to receive live video feeds from each physical electronic gaming terminals and from casino video surveillance, to sort relevant videos, to composite various views into coherent viewing sequences in space and in time, to compress and to send relevant videos to players;
a finance management module for receiving, calculating, sorting, and distributing funds from users as well as from banks dealing with the gaming facility; and
computer hardware/software, cables, optical fiber connections on which the system operates.
